(19) United States
(12) Patent Application Publication
(10) Pub. No.: US 2025/0173684 A1
(43) Pub. Date: May 29, 2025

(54) SYSTEM AND METHOD FOR ASSISTING INTELLIGENT MAINTENANCE FOR SUBWAY VEHICLE, DEVICE AND MEDIUM

(71) Applicant: BEIJING METRO OPERATION CO., LTD. TECHNOLOGY INNOVATION RESEARCH INSTITUTE BRANCH, Beijing (CN)

(72) Inventors: Yun WEI, Beijing (CN); Tingrui CUI, Beijing (CN); Ming LI, Beijing (CN); Hongtao ZHU, Beijing (CN); Minghui DING, Beijing (CN); Jiao ZHANG, Beijing (CN); Zhichao ZANG, Beijing (CN)

(73) Assignee: BEIJING METRO OPERATION CO., LTD. TECHNOLOGY INNOVATION RESEARCH INSTITUTE BRANCH, Beijing (CN)

(21) Appl. No.: 18/437,219

(22) Filed: Feb. 8, 2024

(30) Foreign Application Priority Data
Nov. 24, 2023 (CN) 202311586222.1

(51) Int. Cl. G06Q 10/20; G02B 27/01; G06F 16/34

(52) U.S. Cl. CPC G06Q 10/20; G02B 27/0172; G06F 16/345; G02B 2027/0178

(57) ABSTRACT

Embodiments of this specification provide a system and method for assisting intelligent maintenance for a subway vehicle, a device and a medium. The system includes: a pair of AR smart glasses, configured to scan, identify and display a device under the control of a smart terminal, and cooperatively display a corresponding digital process guidance file; a smart terminal, configured to convert a paper repair process file into a digital process guidance file by means of a built-in process editor, store the digital process guidance file in a back-end system, download the digital process guidance file in the event of repair, inquire device information and maintenance information from the back-end system according to scanning information of the device, generate and submit a digital work order to a maintenance scheduling management system through the back-end system for maintenance task dispatching in response to detecting a fault, generate and submit a repair report to the back-end system, and provide a digital note assistant function; and a back-end system, configured to provide a subway vehicle maintenance database, and docked and integrated with the existing maintenance dispatching management system through an interface.

### TECHNICAL FIELD

This document relates to the field of computer technologies, in particular to a system and method for assisting intelligent maintenance for a subway vehicle, a device and a medium.

### BACKGROUND

A repair operation for a subway vehicle device has a feature that each subsystem has numerous and complicated parts, so it is impossible for repair personnel to remember the repair process and precautions for each part. In particular, with the development of computer information technologies, devices are being updated quickly, so new workflows are often required. However, the traditional method is to have repair personnel carry paper maintenance manuals, technical specifications, etc., to inquire about each step of the repair process at any time. These files are often thick, and inconvenient to carry and inquire, which may cause inconvenience to repair personnel.

Various repair work of the subway vehicle device may require repair personnel to check in one by one, record corresponding values or on-site conditions, and require marking and registration in a maintenance dispatching management system for responsibility tracing and big data analysis of vehicle conditions. Currently, there are two main methods to implement check-in records for such repair processes: 1) making records with a pen in a paper maintenance order, and then regularly transcribing the records into the maintenance scheduling management system through a computer; and 2) developing APP software for checking-in and recording, and installing the APP software in a mobile phone or other mobile terminal, where repair personnel check in and handwrite records during the repair process through the software, and then transfer the records to the maintenance scheduling management system. Both methods have problems such as complex operation, easy omission, and inability to supervise recording results, thus affecting the accuracy and effectiveness of the entire repair records.

A vehicle maintenance department has a large amount of technical data, including maintenance manuals, device drawings, device parameters, repair videos, etc. Some of these data are digitized and stored in the maintenance scheduling management system, and some are still paper materials for engineers and routing inspection personnel to look up. However, because of a large number of data and different formats, there will be three efficiency problems: 1) these data need to be searched manually, which wastes a lot of time; 2) there is no correlation between these data, and corresponding information can be found since complete and accurate keywords must be entered for each search, so for novices or those who are not familiar with information systems, they need to try multiple searches before they acquire target information; and 3) many documents and video data are rich in information and contain a plurality of knowledge points, which can only be presented in a holistic way during retrieval, and must be searched or traversed twice after opening the documents to find desired information points.

An augmented reality (AR) technology is a new technology that “seamlessly” integrates real world information and virtual world information, which simulates and then superposes physical information (vision, sound, taste, touch, and other information) that is difficult to experience in a certain time and space in the real world through computer and other scientific technologies, and applies virtual information to the real world to be perceived by human senses, so as to achieve a sensory experience beyond reality. The real environment and virtual objects are superimposed on the same frame or space in real time and exist at the same time.

AR not only displays real-world information, but also displays virtual information at the same time. The two types of information complement and superimpose each other. In visual augmented reality, a user can use an AR display device to synthesize the real world and computer graphics in multiplex together, and then can see the real world surrounding it.

The AR technology includes new technologies and methods such as multimedia, three-dimensional modeling, real-time video display and control, multi-sensor fusion, real-time tracking and registration, and scene fusion. AR provides information that is different from what human beings can perceive under normal circumstances. An AR system has three outstanding features: (1) integration of information in the real world and the virtual world; (2) real-time interactivity; and (3) the addition and positioning of virtual objects in a three-dimensional scale space. The AR technology may be widely used in military, medical treatment, construction, education, engineering, films and television, entertainment and other fields. With the help of an AR terminal, the virtual world and the real world are intelligently integrated and displayed in front of their eyes. Users can perform command output and control through convenient and intuitive means such as gestures, voice, eye movements and head movements, thus greatly improving the interaction ability between people and devices, information systems and control systems in the industrial Internet and smart manufacturing environments, and achieving the complete and efficient integration of personnel and intelligent systems in modern manufacturing.

### SUMMARY

An object of the present invention is to provide a system and method for assisting intelligent maintenance for a subway vehicle, a device and a medium, which aim to solve the above problems in the existing technology.

The present invention provides a system for assisting intelligent maintenance for a subway vehicle. The system includes:
a pair of AR smart glasses, connected to a smart terminal, and configured to scan, identify and display a device under the control of the smart terminal, and cooperatively display a corresponding digital process guidance file;
a smart terminal, connected to a back-end system, and configured to convert a paper repair process file into a digital process guidance file by means of a built-in process editor, store the digital process guidance file in the back-end system, download the digital process guidance file in the event of repair, inquire device information and maintenance information from the back-end system according to scanning information of the device, generate and submit a digital work order to a maintenance scheduling management system through the back-end system for maintenance task dispatching in response to detecting a fault, generate and submit a repair report to the back-end system, and provide a digital note assistant function; and
a back-end system, composed of servers, configured to provide a subway vehicle maintenance database, and docked and integrated with the existing maintenance dispatching management system through an interface.

The present invention provides a method for assisting intelligent maintenance for a subway vehicle, which is used in the system for assisting intelligent maintenance for a subway vehicle. The method specifically includes:
through a pair of AR smart glasses, scanning, identifying and displaying a device under the control of a smart terminal, and cooperatively displaying a corresponding digital process guidance file;
through the smart terminal, converting a paper repair process file into a digital process guidance file by means of a built-in process editor, storing the digital process guidance file in a back-end system, downloading the digital process guidance file in the event of repair, inquiring device information and maintenance information from the back-end system according to scanning information of the device, generating and submitting a digital work order to a maintenance scheduling management system through the back-end system for maintenance task dispatching in response to detecting a fault, generating and submitting a repair report to the back-end system, and providing a digital note assistant function; and
through the back-end system, storing a subway vehicle maintenance database, and docking and integrating the back-end system with the existing maintenance dispatching management system through an interface.

An embodiment of the present invention further provides an electronic device, including: a memory, a processor, and a computer program stored in the memory and runnable on the processor, where the computer program, in response to being executed by the processor, causes the processor to implement the steps of the method for assisting intelligent maintenance for a subway vehicle.

An embodiment of the present invention further provides a computer-readable storage medium storing an information transfer implementation program, where the program, when being executed by a processor, causes the processor to implement the steps of the method for assisting intelligent maintenance for a subway vehicle.

The embodiments of the present invention can be adopted to effectively solve the problems existing in the existing technology, intelligently display the repair process and steps as well as device information in a near-to-eye manner when repair personnel are working, assist in completing corresponding work, and allow the routing inspection personnel to perform check-in and recording, entry of corresponding data and information, and reporting of digital fault work orders by means of voice or gestures, thereby achieving recording while working, and improving the working efficiency. Meanwhile, the entire working process can also automatically generate repair reports and full-process video recordings and upload them to the back-end system for back-end review and supervision.

### BRIEF DESCRIPTION OF THE DRAWINGS

To describe the technical schemes in one or more embodiments of this specification or in the existing technology more clearly, the accompanying drawings to be used in the description of the embodiments or the existing technology will be briefly introduced below. Apparently, the accompanying drawings in the following description show merely some embodiments stated in this specification, and a person of ordinary skill in the art may still derive other drawings according to these accompanying drawings without creative efforts.

FIG. 1 is a schematic diagram of the composition of a system for assisting intelligent maintenance for a subway vehicle according to an embodiment of the present invention;

FIG. 2 is a schematic diagram of a pair of AR smart glasses and a smart terminal connected thereto according to an embodiment of the present invention;

FIG. 3 is a functional architecture diagram of a system for assisting intelligent maintenance for a subway vehicle according to an embodiment of the present invention;

FIG. 4 is a flowchart of a method for assisting intelligent maintenance for a subway vehicle according to an embodiment of the present invention;

FIG. 5 is a schematic diagram of an operation planning interface according to an embodiment of the present invention;

FIG. 6 is a schematic diagram of voice guidance for performing a repair operation step by step according to an embodiment of the present invention;

FIG. 7 is a schematic diagram of performing a repair operation step by step and viewing attachments according to an embodiment of the present invention;

FIG. 8 is a schematic diagram of each functional area of a digital process editing interface according to an embodiment of the present invention;

FIG. 9 is a schematic diagram of a digital process editing effect diagram according to an embodiment of the present invention;

FIG. 10 is a schematic diagram of a digital note assistant function display interface according to an embodiment of the present invention;

FIG. 11 is a schematic diagram of uploading a repair report according to an embodiment of the present invention;

FIG. 12 is a schematic diagram of a repair execution operation recording interface of a back-end system after the repair report is uploaded according to an embodiment of the present invention;

FIG. 13 is a schematic diagram of a fault order filling page according to an embodiment of the present invention;

FIG. 14 is a schematic diagram of a functional interface for intelligent data inquiry by scanning an object device with a pair of AR smart glasses according to an embodiment of the present invention;

FIG. 15 is a repair operation execution flowchart of a method for assisting intelligent maintenance for a subway vehicle according to an embodiment of the present invention; and

FIG. 16 is a schematic diagram of an electronic device according to an embodiment of the present invention.

### DETAILED DESCRIPTION

In order for those having ordinary skill in the art to understand the technical schemes in one or more embodiments of the present description better, the technical schemes in one or more embodiments of the present description will be described clearly and completely in conjunction with the accompanying drawings in one or more embodiments of the present description. Apparently, the described embodiments are merely some embodiments, rather than all embodiments, of the present description. Based on one or more embodiments of the present description, all other embodiments obtained by those having ordinary skill in the art without creative efforts should fall within the protection scope of this document.

### System Embodiment

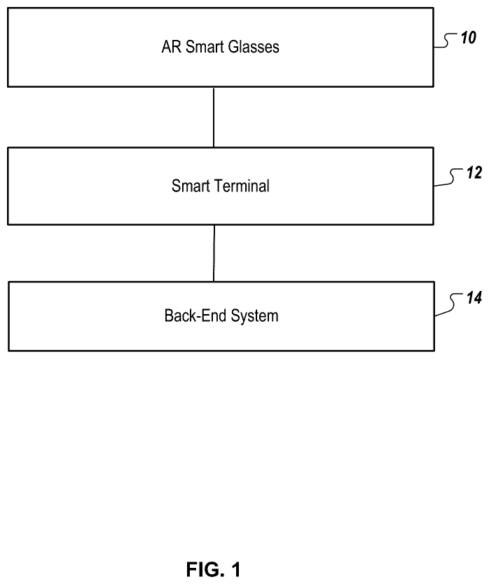

According to an embodiment of the present invention, a system for assisting intelligent maintenance for a subway vehicle is provided. FIG. 1 is a schematic diagram of the composition of a system for assisting intelligent maintenance for a subway vehicle according to an embodiment of the present invention. As shown in FIG. 1, the system for assisting intelligent maintenance for a subway vehicle according to the embodiment of the present invention specifically includes:
a pair of AR smart glasses 10, connected to a smart terminal, and configured to scan, identify and display a device under the control of the smart terminal, and cooperatively display a corresponding digital process guidance file, the AR smart glasses 10 being specifically configured to:
acquire a voice command, a gesture command or an action command inputted by a user to control proceeding, photographing, video recording, recording and ending of operation steps in the digital process guidance file;
a smart terminal 12, connected to a back-end system, and configured to convert a paper repair process file into a digital process guidance file by means of a built-in process editor, store the digital process guidance file in the back-end system, download the digital process guidance file in the event of repair, inquire device information and maintenance information from the back-end system according to scanning information of the device, generate and submit a digital work order to a maintenance scheduling management system through the back-end system for maintenance task dispatching in response to detecting a fault, generate and submit a repair report to the back-end system, and provide a digital note assistant function, the smart terminal 12 being specifically configured to:
by means of a built-in process editor, provide a user with a function of graphically editing an operation process directly in a view area, and convert a paper repair process file into a digital process guidance file, where the digital process guidance file includes a plurality of complete routing repair operation plans and auxiliary information, where the routing inspection operation plans include a plurality of orderly operation steps, and types of the auxiliary information include videos, models, photos, voice and text; and
acquire feedback information inputted by the user during repair through the digital note assistant function and record the feedback information, where the feedback information specifically includes: information about whether the repair has passed, current device status information, and/or device problem description information; and
a back-end system 14, composed of servers, configured to provide a subway vehicle maintenance database, and docked and integrated with the existing maintenance dispatching management system through an interface, where the subway vehicle maintenance database specifically includes: a maintenance process database, a device information database, a maintenance record database and an employee information database.

The above technical schemes of the embodiments of the present invention will be described in detail below with reference to the accompanying drawings.

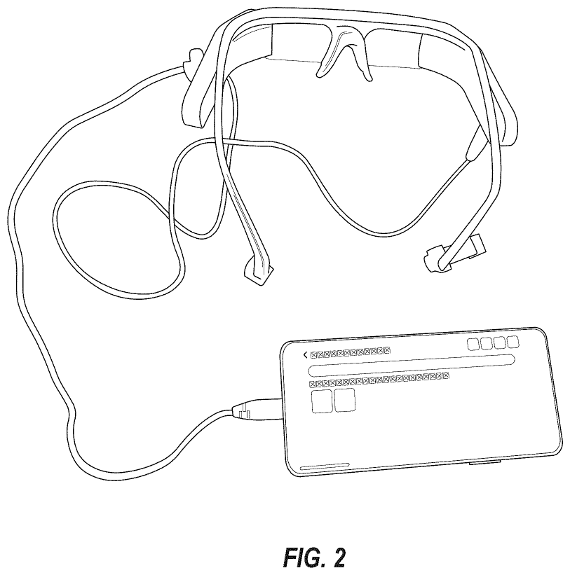

The system for assisting intelligent maintenance for a subway vehicle is composed of a front end and a back end as a whole. A front-end terminal system consists of a pair of AR smart glasses as shown in FIG. 2 and a smart terminal (a mobile phone, a tablet, PDA, etc.) connected thereto. A customized APP is installed on the smart terminal to drive the glasses and connect the back-end system. The entire terminal is connected to the back-end system through a 4G, 5G or WiFi network.

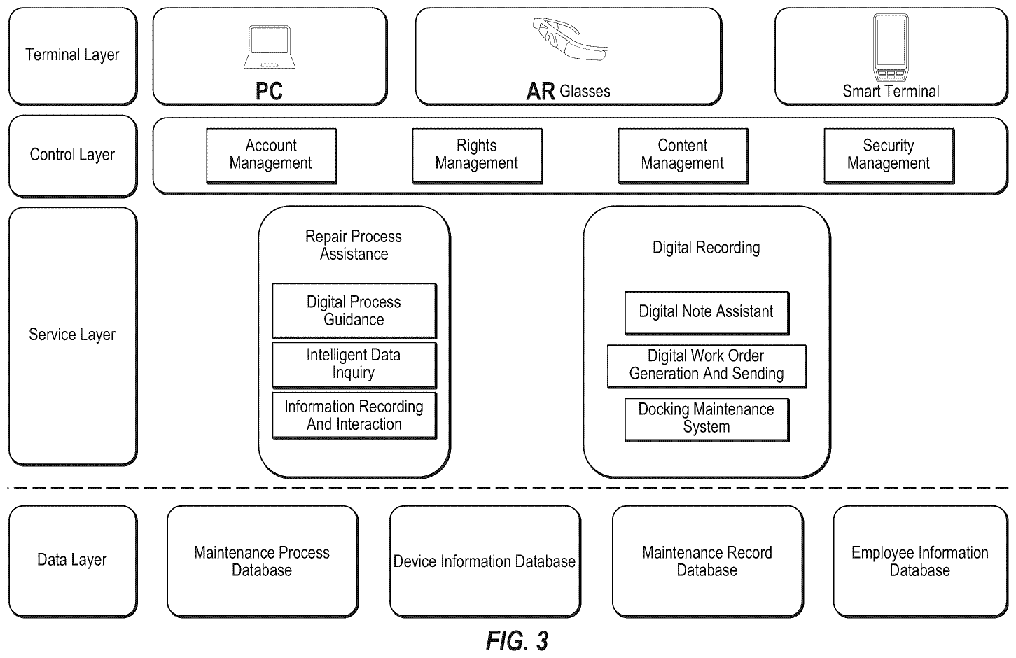

As shown in FIG. 3, a back-end data layer is composed of servers, taken as a core part of the entire system, configured to provide various service functions, process and step auxiliary guidance, digital work orders, device information knowledge bases, etc., and provided with corresponding database systems. Meanwhile, this platform has a northbound interface, which may be docked and integrated with the existing maintenance scheduling management system to form an integral platform that enables enterprises to perform daily operation and maintenance, routing inspection, repair and other functions by means of the AR smart glasses and the smart terminal. Back-end management personnel is connected to the platform through a browser of a PC, mobile phone or tablet computer to achieve real-time communication with a front-end glasses wearer. The entire platform may be installed in an internal IDC of Beijing Metro, or installed in a physical server, a cloud server and a virtual server. Purely private IP addresses should be used to ensure the security of the system.

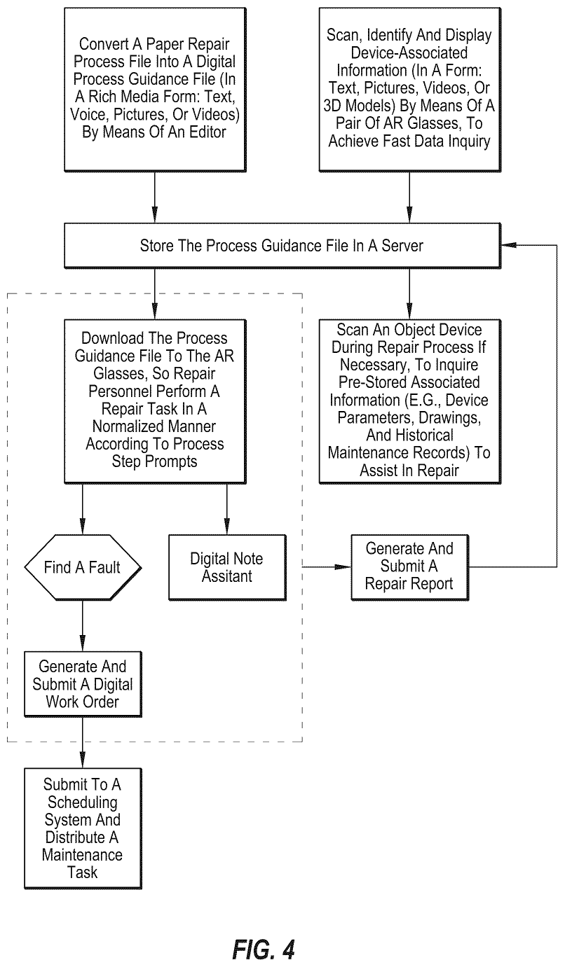

For a very sophisticated and complex device, there are many maintenance processes, long steps, and many precautions. Repair personnel often need to look up a text work flowchart frequently. Mistakes will be caused if they are not careful, thereby bringing great risks to the normal operation of the subway. However, a process assistance function may be used to effectively prevent this phenomenon. A flowchart of a method for assisting intelligent maintenance for a subway vehicle is shown in FIG. 4.

### (1) Description of Standard Process Editor

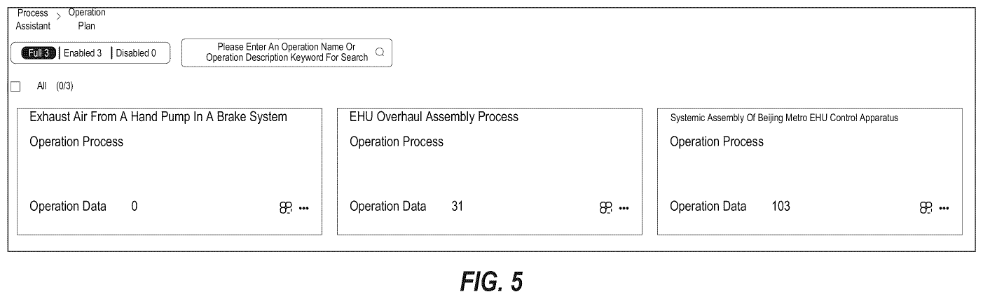

The system for assisting intelligent maintenance will provide a tool to help an administrator convert repair procedures, routing inspection processes, etc. in a maintenance manual into digital process files, and specify the actions and objectives of each step in detail. These process files are stored in the back-end system and may be downloaded by front-line repair personnel to the smart terminal for execution. The process files are presented in FIGS. 5-7 as a virtual frame in the AR smart glasses. The virtual frame may be superimposed on the real world.

Operation plans exist as digital files that may be assigned to different accounts. The operation file may be seen in the APP in response to logging in with the account. A smart terminal execution mode is enabled in response to clicking.

The standard process editor which is developed in the system for assisting intelligent maintenance for a subway vehicle helps the administrator convert repair procedures, routing inspection processes, etc. in the maintenance manual into digital process files, and specifies the actions and objectives of each step in detail. These process files are stored in the back-end system and may be downloaded by front-line repair personnel to the smart terminal for execution.

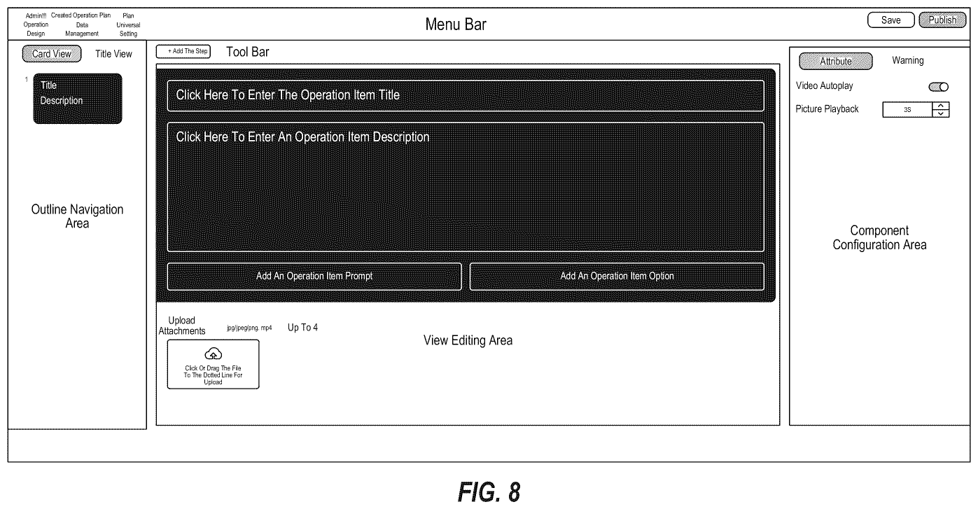

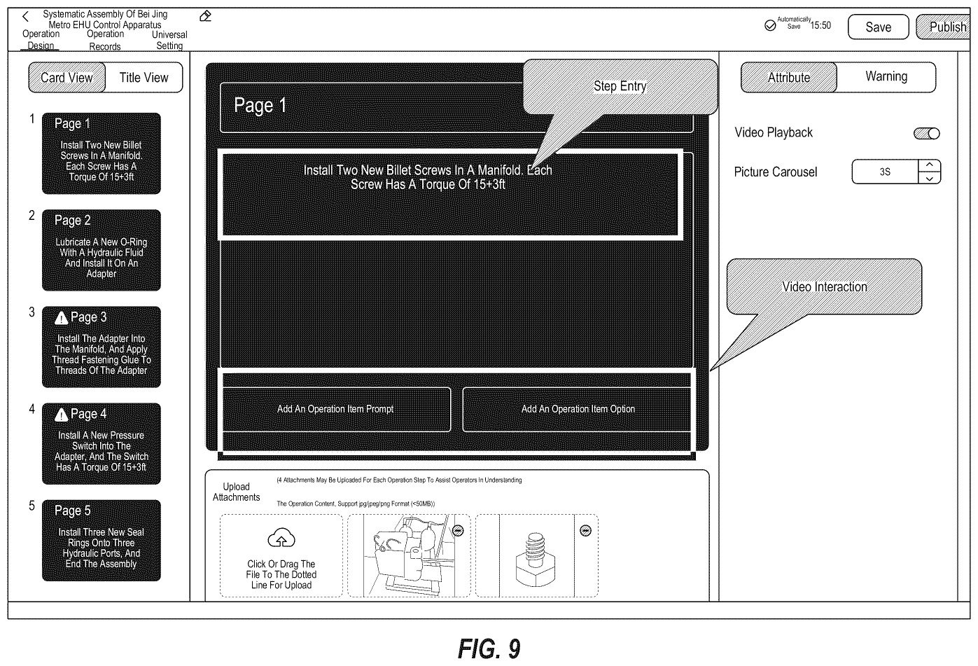

The editor consists of a menu bar/outline navigation/view editing/component configuration area and other functional areas. A user may edit an operation process graphically directly in a view area. This mode has the advantage of short learning time, i.e., what you see is what you get. Functional areas of a standard process interface are shown in FIG. 8 and FIG. 9. In this interface, the content of each step may be formulated and connected in series to form a complete operation. In the course of editing the content in the steps, the title, content, record type, alarm information, attachment data, etc. may be edited, and a style presented on a web interface may also be presented in the AR smart glasses, realizing “what you see is what you get”.

The system supports two levels of nesting of operation plans, that is, a plurality of steps may be gathered into one chapter, and a plurality of chapters may constitute a complete operation plan. This mode is very helpful for the routing inspection of the subway vehicle and other complex devices. These devices have the characteristic that the whole device is composed of a plurality of parts, and each part is divided into a plurality of routing repair steps. In this way, the repair of each part is made into a chapter. Each step is listed below in detail, so that the personnel can freely select a target chapter of this repair operation in the operation plan for operation, or execute the chapters one by one, thereby achieving high flexibility.

After the entire operation plan is created, the operation may be named, filled with a description, and classified (e.g., a routing inspection task, a maintenance task or a warranty task). In response to selecting whether to record the whole process and set standard working hours (optional), a complete routing inspection operation plan is completed.

The administrator may input these steps into the system for assisting intelligent maintenance for a subway vehicle and compile them into an AR digital process file. A process editing interface is shown in FIG. 8 and FIG. 9.

A left screen is an attachment display area. If auxiliary information such as videos, models, photos, and text are inserted in this step, they will be displayed here. The personnel may select these contents to view through the voice command, the gesture command, or the action command. The middle part is a homework area in which the content of the operation steps and a feedback interface are displayed.

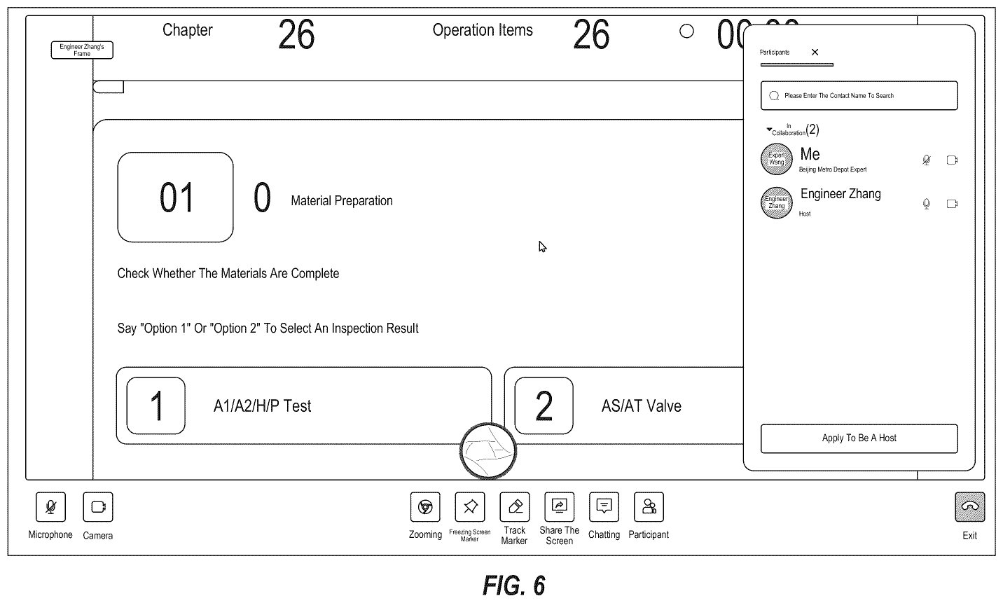

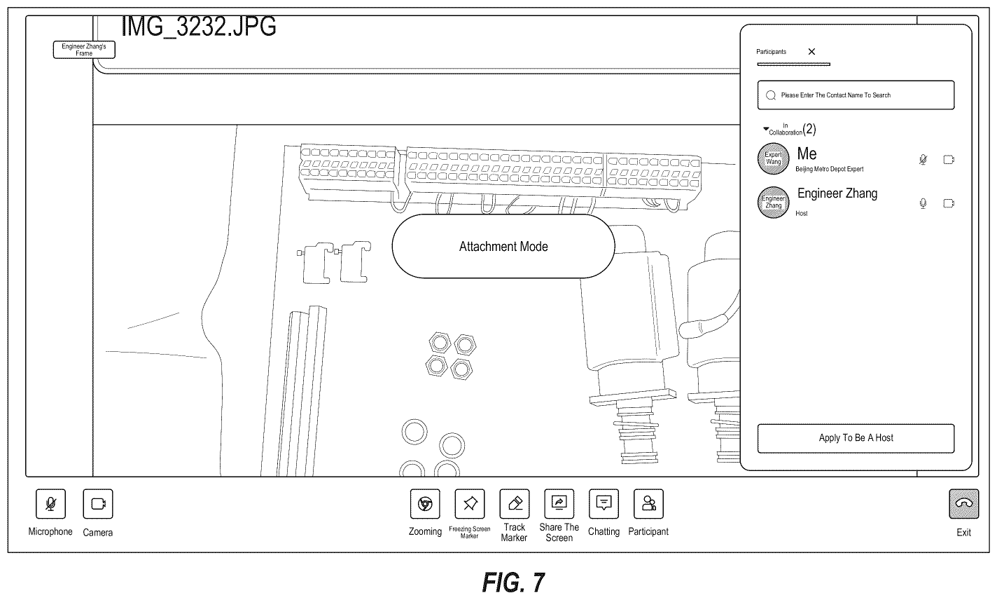

In response to entering an AR routing inspection operation, the step content is displayed in FIG. 6 and FIG. 7. The title, content and expected feedback results of this step will be listed, and the personnel may perform the operation according to a prompt. During the operation, the personnel may control proceeding, photographing, recording and ending, etc. of steps through a voice command, without using both hands. After the entire operation is completed, the smart terminal may automatically generate a repair report, including information such as a step completion status and operation records, as well as records of photographing and dotting. If the operation plan stipulates that the entire process needs to be recorded, video recording information of the entire process may also be included in a report. After completion, the report will first be stored in the smart terminal, then uploaded to the back-end system, and finally used for printing or sent to a maintenance dispatching management system.

Before a subway vehicle-related device is installed, in response to clicking to open a process file, instructions and warning information for this step will first appear in the AR smart glasses. The personnel may check their tool lists based on these information to ensure that all the lists are in place, then make a contact network/third rail power-off operation well according to a caution, and then perform a formal step operation through keys or voice words. Words, e.g., “manually release a selector valve”, in the first step will appear, and there will also be a voice prompt to guide the personnel to perform this action. After completing this step, if the personnel confirm through keys or voice words, the next step “open an exhaust nozzle” may proceed automatically, and so on. The personnel will operate these instructions one by one. Next step can only be performed after confirmation of each step, thus eliminating the possibility of the personnel missing some important operations. After all steps are completed, ending is confirmed with keys or voice words, then a process file exits, and a repair report is automatically generated on the smart terminal.

### A Digital Note Assistant Function:

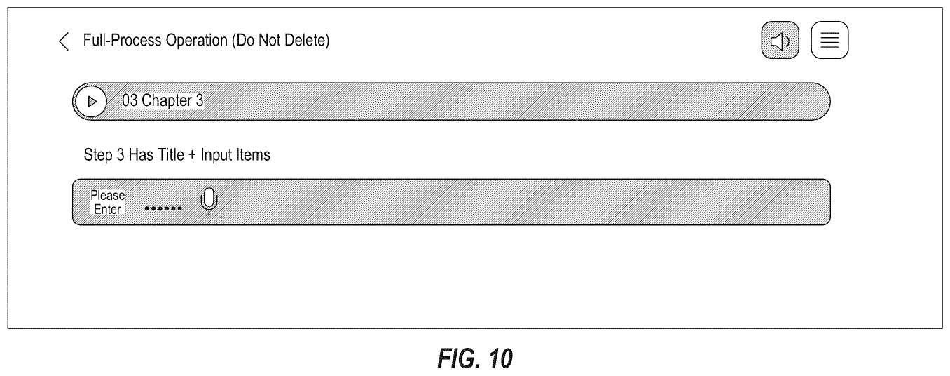

Many repair steps require the personnel to input some feedback information. This feedback is divided into two types. The first type is a selection, that is, passing or failing, etc., and several possible selections for the current device status, etc. The other type is a description of a device status or problem. The function display is shown in FIG. 10. This system supports the personnel wearing the AR smart glasses to input data and comments through voice, and automatically converts them into text for storage; and records working moments like a little assistant, which is convenient and efficient. The data is updated in real time, so any important information cannot be missed. Details recorded by all digital note assistants may be displayed in association with this operation execution plan.

Auxiliary maintenance also has a function of recording the entire process. When the personnel start to execute the process file, a high-definition camera on the AR smart glasses may record the on-site repair process from a first perspective.

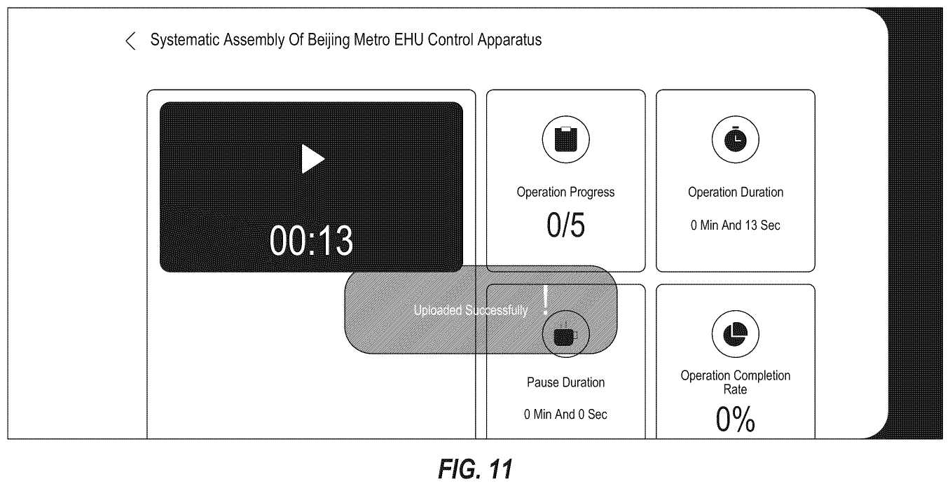

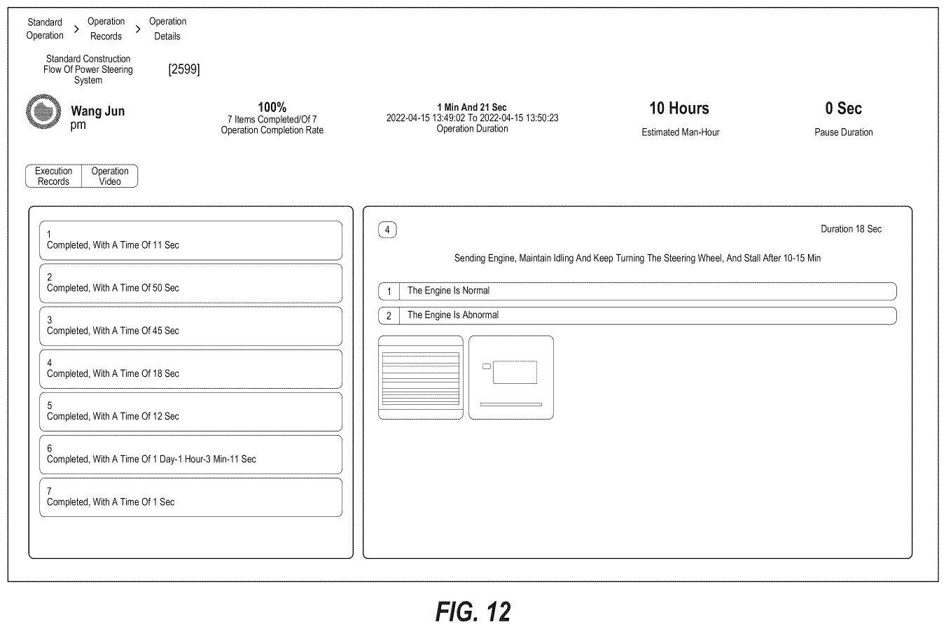

After the entire process file is executed, a repair report is automatically generated, which includes time points, locations, input data, comments, entire process recording videos, etc. of various steps. The repair report may be automatically uploaded to the back-end system in the case of network connection for management personnel to check and trace. After the report is uploaded, an interface of the smart terminal is shown in FIG. 11. An interface of the back-end system is shown in FIG. 12. The records, feedback and real-time videos during the entire operation are recorded in the repair report.

Considering that network conditions of many repair sites are unstable and are difficult to be online at any time, an auxiliary maintenance function may be operated in an offline mode, that is, the personnel download the entire process file to the smart terminal before the operation, so no networking is required during the execution process. All data information is temporarily stored in the smart terminal. The repair report after the operation is also stored in the smart terminal and then is automatically uploaded in the case of a network connection.

### A Digital Work Order Submitting Function:

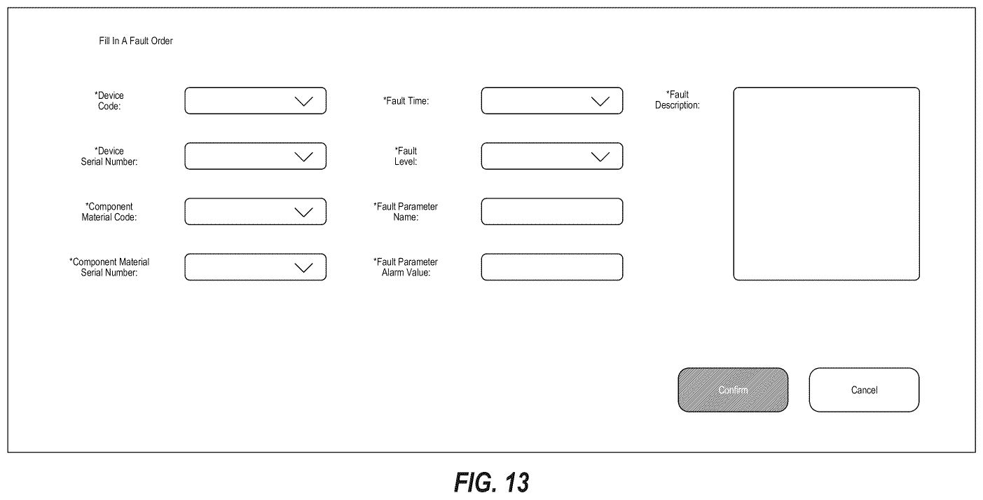

If a fault is found during the repair process, a digital work order may be submitted at any time, and a fault order filling page may be invoked on the smart terminal, as shown in FIG. 13. During the filling process, the AR smart glasses side is replaced with an empty page to remind the user that the fault order is being filled in.

The field requirements are as shown in the table below. Required fields and formats are verified in the course of confirming.

TABLE 1
Fault order filling requirements

| | | Entry | |
|---|---|---|---|
| Field | Required | method | Format requirements |
| Device | Required | Single | A customer provides a drop-down |
| number | | choice | dictionary; there is no cascading |
| | | | relationship with a device serial |
| | | | number; |
| Device | Required | Single | The customer provides a drop-down |
| serial | | choice | dictionary |
| number | | | |
| Component | | Single | Change to enter fields manually, with |
| material | | choice | the same fault parameter name |
| code | | | |
| Component | | Single | Change to enter fields manually, with |
| material | | choice | the same fault parameter name |
| serial | | | |
| number | | | |
| Failure time | Required | Single | Accurate to minute |
| | | choice | |
| Failure level | Required | Single | Options: first-level fault, second-level |
| | | choice | fault, third-level fault, fourth-level |
| | | | fault |
| Fault | | Manual | Within 20 words, no format limit |
| parameter | | entry | |
| name | | | |
| Fault | | Manual | Within 20 words, no format limit |
| parameter | | entry | |
| alarm value | | | |
| Fault | Required | Manual | Within 100 words, no format limit |
| description | | entry | |

The fault order, which has been filled in completely, is uploaded and submitted to the maintenance dispatching management system, and then pushed to an account of certain repair personnel after making a decision by the maintenance dispatching management system.

### Example 1—Repair Operation

Taking a cleaning process of a control apparatus for a hydraulic brake system of a subway vehicle as an example, this process has a total of eight steps which need to be strictly performed one by one. The steps are shown as follows:
1) cleaning a manifold with hydraulic oil and blowing to dryness with compressed air (attachment: two pictures);
2) cleaning all-metal parts and rubber-free joined metal components with a chemical cleaner in an ultrasonic bath at 70-80° C., and then blowing to dryness with compressed air (attachment: one video);
3) cleaning non-metal parts with lukewarm soapy water, then rinsing immediately with clean water, and blowing to dryness with compressed air;
4) removing a sealing assembly prior to cleaning a valve;
5) cleaning the outside of the valve with a soapy water solution with a brush, and then blowing to dryness with compressed air;
6) rinsing the valve carefully with a clean, filtered hydraulic fluid, in order to remove dirt from the inside of the valve;
7) cleaning a pressure sensor with a chemical cleaner, and cleaning a hydraulic port by blowing to dryness with compressed air; and
8) cleaning external rubber and plastic parts with warm soapy water, then rinsing them immediately with clean water, and blowing to dryness with compressed air.

The administrator may input these steps into the system for assisting intelligent maintenance for a subway vehicle and compile them into a cleaning process file for an AR digital EHU control apparatus. The personnel can click on this file to download and save it to an AR terminal when EHU needs to be cleaned.

Prior to cleaning the EHU and after clicking to open the process file, the instructions and warning information for this step will first appear in the AR smart glasses. The personnel may check their tool lists based on these information to ensure that all the lists are in place, and then perform a normal step operation through keys or voice words. Words, e.g., “Clean a manifold”, in the first step will appear, and there will also be a voice prompt to guide the personnel to perform this action. Pre-stored picture auxiliary information may be viewed at the AR smart glasses by a voice command “Open Attachment” or by a key. After completing this step, if the personnel confirm through keys or voice words, the next step “Clean metal component” may proceed automatically, auxiliary video information may also be viewed by a voice command and voice words, and so on. The personnel will operate these instructions one by one. Next step can only be performed after confirmation of each step, thus eliminating the possibility of the personnel missing some operations. After all steps are completed, ending is confirmed with keys or voice words, then a process file exits, and a repair report is automatically generated on the smart terminal.

The attachment functions are explained below. In the course of executing each step, auxiliary information for this step also needs to be inquired. Using the system for assisting intelligent maintenance for a subway vehicle, the personnel may call corresponding data for reference during the working process, without affecting their own work. For example, in the step 1 of inspecting the EHU cleaning process, two picture attachments are stored. When this step is performed, pre-stored pictures may be viewed at the AR smart glasses through the voice command “Open Attachment” or by a key. The personnel can view and operate at the same time, thereby greatly improving the efficiency.

Functional description of intelligent data inquiry: the AR smart glasses scan an object device for intelligent identification, and then call associated data stored in a database and present the associated data in real time at the glasses. The presentation form may be text, pictures, videos, or 3D models. For example, scanning “Control apparatus for hydraulic brake system” during the repair process may allow parameters, drawings, process files, fault records, repair cycles, etc. of this device to be viewed at the glasses.

Description of digital note assistant: many repair steps require the personnel to input some measured indicator data or make some comments. This system supports the personnel wearing the AR smart glasses to input data and comments through voice, and automatically convert them into a text for storage. For example, in the above-mentioned fresh air filter net cleaning process, if it is found that there are small hidden dangers in a filter net that require subsequent attention, a recording mode can be called, and the problems found by the personnel himself/herself are recorded with voice. The smart terminal may convert the problems into a text and save the text in the report.

Description of digital work order: for example, in the above-mentioned process of cleaning a pressure sensor, if there is a fault with the sensor that needs to be maintained immediately, a digital work order function may be used to report the fault in real time.

Auxiliary maintenance also has a function of recording a video of the entire process. When the personnel starts to execute a process file, the high-definition camera on the AR smart glasses may record the on-site repair process from a first perspective. During the fresh air filter net cleaning process, the camera of the AR smart glasses may record the entire process of the personnel from removing, cleaning to reinstallation.

After the entire process file is executed, a repair report is automatically generated, which includes time points, locations, input data, comments, entire process recording videos, etc. of various steps. The repair report may be automatically uploaded to the back-end system in the case of network connection for management personnel to check and trace.

### Example 2—Method for Creating a Digital File in a Repair Operation

an editing interface for creating the digital file is shown in FIG. 8 and FIG. 9.

Taking the assembly of the control apparatus as an example, this process has 22 work items, plus secondary work items, a total of 34 work items, as shown in the following table:

TABLE 3
Assembly and disassembly processes

| Serial | |
|---|---|
| No. | Process |
| 1 | Install two new billet screws (12) in a manifold (2). Each screw |
| | (12) has a torque of 15 + 3 ft-lb. |
| 2 | Slightly lubricate a new O-ring (4) with a hydraulic fluid and |
| | install the new O-ring on an adapter (3). |
| 3 | Install the adapter (3) into the manifold (2). Apply thread fastening |
| | glue to threads of the adapter (3), having a torque of 42 +/− 3 |
| | ft-lb. |
| 4 | Install a new pressure switch (22) into the adapter (3). The pressure |
| | switch (22) has a torque of 15 + 3 ft-lb. |
| 5 | Install three new seal rings (30) onto three hydraulic ports. |
| 6 | Install and fasten a 160 bar pressure sensor (31), two 100 bar |
| | pressure sensors (29) and (47), having a torque of 18.5 + 4 ft-lb. |
| 7 | Install two MV501 magnetic valves (23) as follows: |
| | 7.1 Scrub a 12VDC magnetic valve hole in the manifold (2) with |
| | the hydraulic fluid used in operation. |
| | 7.2 Slightly lubricate five new O-rings (25, 26, and 27) with |
| | hydraulic fluid. |
| | 7.3 Place the five new O-rings onto a magnetic valve armature |
| | (54). |
| | 7.4 Press the magnetic valve armature (54) to a lubrication hole in |
| | its manifold (2). |
| | 7.5 Install screws (53) diagonally to fasten the magnetic valve |
| | armature (54) onto the manifold (2). Each screw has a torque of |
| | 2.2 + 0.7 ft-lb. Apply a Molycote metal protectant to the |
| | threads of the screws (53). |
| 8 | Place an electromagnetic coil (56) onto the magnetic valve |
| | armature (54). |
| 9 | Slightly lubricate a new O-ring (24) with hydraulic fluid. |
| 10 | Slide the new O-ring (24) to the magnetic valve armature (54). |
| 11 | Manually tighten a knurled nut (55) onto the magnetic valve |
| | armature (54). |
| 12 | Slightly lubricate O-rings (37) and (38) with hydraulic fluid on two |
| | MV519US magnetic valves (35). |
| 13 | Install the MV519US magnetic valves (35) onto the manifold (2). |
| | Each valve has a torque of 18.5 + 4 ft-lb. |
| 14 | Press four new AS/AT analog control valves (39) into the manifold |
| | (2). Apply the Molycote metal protectant to the threads of the |
| | screws, and each screw on the analog control valve has a torque of |
| | 37 + 0.7 ft-lb. |
| 15 | Tighten two terminal plate support studs (40) onto the manifold |
| | (2). Each stud has a torque of 3.7 + 0.7 ft-lb. |
| 16 | Place a terminal rail (13) on the support studs (40). |
| 17 | Apply the Molycote metal protectant to the threads of the screw |
| | (52), and install a screw at the end of the terminal rail (13). |
| 18 | If it is necessary to disassemble or replace a terminal board |
| | assembly due to damage or circuit failure, the following content |
| | proceeds as follows: |
| | 18.1 Install a clip (14) to the terminal rail (13) from right to left. |
| | 18.2 Install eighteen new terminal boards (20) onto the terminal |
| | rail (13). All terminal boards should be adjacent. |
| | 18.3 Secure the terminal board (20) to the terminal rail (13) by |
| | attaching the clip (14) to the terminal rail adjacent to a left partition |
| | plate. |
| | 18.4 If any of terminal labels (16), (17), (18) and (45) is unclear or |
| | missing, replace an appropriate label. |
| | 18.5 Install jumper wires (46) and (19) on the terminal board (20), |
| | having a torque of 64 + 8 ft-lb. |
| | 18.6 Install a diode (41) onto the terminal board (20). |
| | 18.7 Fix the clip (14) with a screw. |
| 19 | Provide a new O-ring (21) on a connector cable to a cable |
| | connector (5). |
| 20 | Thread the connector cable through an opening in a framework (7). |
| 21 | Stabilize a connector (5) to the framework (7) with four screws |
| | (51). Each screw has a torque of 2 + 0.7 ft-lb. Apply a Molycote |
| | metal protectant to the threads of four M5 × 16 mm long screws |
| | (51). |
| 22 | Connect valve leads to the terminal board (20). |

After being injected into the standard process and made into a digital file, this process will be composed of 22 work cards, where the title is entered as a serial number, and the content is filled in as the work content of the above process. The relevant pictures and videos corresponding to each step of the process file may be placed in the digital file as attachments.

After the digital file is made, the digital file may be stored in the back-end system and downloaded to the smart terminal for execution by repair personnel before work.

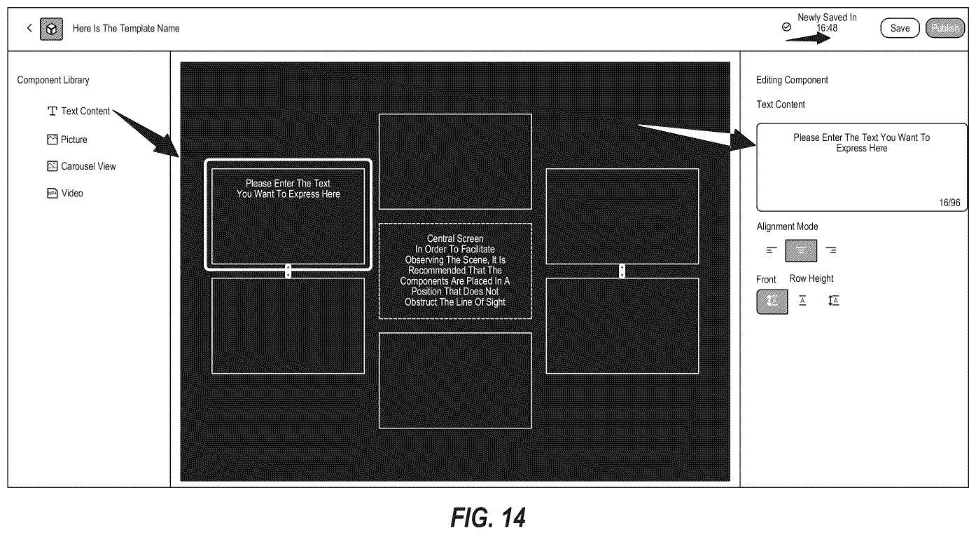

In summary, it can be seen from the above technical scheme that the embodiments of the present invention can implement:
1. Guidelines for digital process files. The system for assisting intelligent maintenance for a subway vehicle converts the repair procedures, routing inspection processes, etc. on the paper maintenance manual into digital process files, including pictures, videos, text, and voices, specifies the actions and objectives of each step in detail, and sets warning for key steps. These process files are stored in the back-end system, downloaded by front-line personnel to the smart terminal for near-to-eye display, and executed in the repair operation. Therefore, the standardization and normalization of repair operations may be achieved.
2. Digital recording. Meanwhile, the entire working process may also be recorded and traced. After completing each operation step, the AR smart glasses and the smart terminal are used to take pictures, convert voice to text, etc., in order to check in and store evidence. Eventually, after all repair steps are completed, a customized repair report will be automatically generated, and the camera of the AR smart glasses may also be used to record the whole process and upload it to the back-end system for review and supervision. If a fault is found during the repair process, a fault order function can be called at any time, and specified fields (fault device codes, fault name, fault description, fault time, etc.) may be filled in to form a digital work order. The fault order content may be automatically inserted into the generated repair report in the corresponding step. Therefore, the digitalization of the repair operations may be achieved.
3. Intelligent data inquiry. This function can realize intelligent identification by scanning an object device by means of the AR smart glasses, and then call associated data stored in a database and present the associated data in real time at the glasses. An editing interface for this function is shown in FIG. 14. The presentation form may be text, pictures, videos, or 3D models. The inquiry and display of device parameters, drawings, process files, fault records, maintenance cycles, etc. in the repair process may be conveniently realized. Therefore, the intelligentization of the repair operations may be achieved.

A repair operation for a subway vehicle has a feature that each subsystem has numerous and complicated parts, so it is impossible for repair personnel to remember the repair process and precautions for each part. In particular, vehicle devices are being updated quickly, so new workflows are often required. However, the traditional method is to have repair personnel carry paper maintenance manuals, to inquire about each step at any time. These manuals are often thick, and inconvenient to carry and inquire, which may cause inconvenience to repair personnel.

Various repair work of the subway device may require repair personnel to check in one by one, record corresponding values or on-site conditions, and require marking and registration in a maintenance dispatching management system for responsibility tracing and big data analysis of vehicle conditions. Currently, there are two main methods to implement check-in records for such repair processes: 1) making records with a pen in a paper maintenance order, and then regularly transcribing the records into the maintenance scheduling management system through a computer; and 2) developing APP software for checking-in and recording, and installing the APP software on a mobile phone or other mobile terminal, where repair personnel check in and handwrite records during the repair process through the software, and then transfer the records to the maintenance scheduling management system. Both methods have problems such as complex operations, easy omissions, and inability to supervise the recording results, thus affecting the accuracy and effectiveness of the entire repair records. With this method, after completing each operation step, the smart terminal is used to take pictures, convert voice to text, etc., in order to check in and store evidence. Eventually, after all repair steps are completed, a customized repair report will be automatically generated. If a fault is found during the repair process, a fault order function may be called at any time, and specified fields (fault device codes, fault name, fault description, fault time, etc.) may be filled in to form a digital work order. The back-end management personnel may receive the digital work order, and then distribute the assigned repair tasks.

In the repair process, if technical specifications, maintenance records, etc. need to be inquired by means of traditional inquiry methods for parameters, drawings, historical faults and the like of the parts, by means of this method, an object may be scanned conveniently, and thus relevant graphic information may be presented at the AR smart glasses, greatly improving the working efficiency and repair quality.

With the adoption of this system, as a key link previously separated from the overall digital operation and maintenance management system, the front-line maintenance and routing repair personnel are fully integrated into the entire system, so that they can easily and quickly access rich data information in the back-end system anytime and anywhere, receive real-time maintenance guidance and training, and accept process step guidance while working, thereby achieving maintenance and routing inspection tasks in the form of digital work orders. These functions have brought many benefits and conveniences to front-line personnel, including: 1) technical skills can be improved practically; 2) mistakes in work can be effectively reduced; and 3) problems can be quickly fed back and solved in time. In addition to getting help from the entire system, front-line personnel can also become contributors to the system and knowledge base, and their videos of asking for help can become troubleshooting examples and materials for other front-line personnel to learn. By means of the digital work order system, the repair report can be completed while working; and after the work is completed, the routing inspection data can be automatically uploaded and stored.

### Method Embodiment

According to an embodiment of the present invention, a method for assisting intelligent maintenance for a subway vehicle is provided, which is used in the system for assisting intelligent maintenance for a subway vehicle. FIG. 15 is a repair operation execution flowchart of a method for assisting intelligent maintenance for a subway vehicle. As shown in FIG. 15, the method for assisting intelligent maintenance for a subway vehicle specifically includes following steps:
S1801: through a pair of AR smart glasses, scanning, identifying and displaying a device under the control of a smart terminal, and cooperatively displaying a corresponding digital process guidance file, specifically including:
acquiring a voice command, a gesture command or an action command inputted by a user to control proceeding, photographing, video recording, recording and ending of operation steps in the digital process guide file;
S1802: through the smart terminal, converting a paper repair process file into a digital process guidance file by means of a built-in process editor, storing the digital process guidance file in a back-end system, downloading the digital process guidance file in the event of repair, inquiring device information and maintenance information from the back-end system according to scanning information of the device, generating and submitting a digital work order to a maintenance scheduling management system through the back-end system for maintenance task dispatching in response to detecting a fault, generating and submitting a repair report to the back-end system, and providing a digital note assistant function, where the converting a paper repair process file into a digital process guidance file by means of a built-in process editor specifically includes:
by means of a built-in process editor, providing a user with a function of graphically editing an operation process directly in a view area, and converting a paper repair process file into a digital process guidance file, where the digital process guidance file includes a plurality of complete routing repair operation plans and auxiliary information, the routing inspection operation plans include a plurality of orderly operation steps, and types of the auxiliary information include videos, models, photos, voice and text; and
the providing a digital note assistant function specifically includes:
acquiring feedback information inputted by the user during repair through the digital note assistant function and recording the feedback information, where the feedback information specifically includes: information about whether the repair has passed, current device status information, and/or device problem description information; and
S1803: through the back-end system, storing a subway vehicle maintenance database, and docking and integrating the back-end system with the existing maintenance dispatching management system through an interface, where the subway vehicle maintenance database specifically includes: a maintenance process database, a device information database, a maintenance record database and an employee information database.

### Apparatus Embodiment One

An embodiment of the present invention provides an electronic device. As shown in FIG. 16, the electronic device includes a memory 190, a processor 192, and a computer program stored in the memory 190 and runnable on the processor 192, where the program, when executed by the processor 192, causes the processor to implement the steps in the method embodiment.

### Apparatus Embodiment Two

An embodiment of the present invention provides a computer-readable storage medium storing an information transfer implementation program, where the program, when executed by a processor 192, causes the processor to implement the steps in the method embodiment.

The computer-readable storage medium described in this embodiment includes, but is not limited to: ROM, RAM, a disk, a compact disc, or the like.

It should be eventually noted that: the above embodiments are merely used to illustrate the technical schemes of the present invention, but are not used to limit the same. Although the present invention is described in detail with reference to the above embodiments, those having ordinary skill in the art should understand: the technical schemes described in the foregoing embodiments may be modified, or some or all of the technical features may be equivalently substituted. However, these modifications and substitutions do not make the corresponding technical schemes essentially depart from the scope of the technical schemes in the embodiments of the present invention.

1. A system for assisting intelligent maintenance for a subway vehicle, comprising:
a pair of AR smart glasses, connected to a smart terminal, and configured to scan, identify and display a device under the control of the smart terminal, and cooperatively display a corresponding digital process guidance file;
a smart terminal, connected to a back-end system, and configured to convert a paper repair process file into a digital process guidance file by means of a built-in process editor, store the digital process guidance file in the back-end system, download the digital process guidance file in the event of repair, inquire device information and maintenance information from the back-end system according to scanning information of the device, generate and submit a digital work order to a maintenance scheduling management system through the back-end system for maintenance task dispatching in response to detecting a fault, generate and submit a repair report to the back-end system, and provide a digital note assistant function; and
a back-end system, composed of servers, configured to provide a subway vehicle maintenance database, and docked and integrated with the existing maintenance dispatching management system through an interface.

2. The system of claim 1, wherein the smart terminal is specifically configured to: by means of a built-in process editor, provide a user with a function of graphically editing an operation process directly in a view area, and convert a paper repair process file into a digital process guidance file, where the digital process guidance file comprises a plurality of complete routing inspection operation plans and auxiliary information, where the routing inspection operation plans comprise a plurality of orderly operation steps, and types of the auxiliary information comprise videos, models, photos, voice and text.

3. The system of claim 1, wherein the pair of AR smart glasses is specifically configured to:
acquire a voice command, a gesture command or an action command inputted by a user to control proceeding, photographing, video recording, recording and ending of operation steps in the digital process guidance file.

4. The system of claim 1, wherein the smart terminal is specifically configured to:
acquire feedback information inputted by the user during repair through the digital note assistant function and record the feedback information, wherein the feedback information specifically comprises: information about whether the repair has passed, current device status information, and/or device problem description information.

5. The system of claim 1, wherein the subway vehicle maintenance database specifically comprises: a maintenance process database, a device information database, a maintenance record database and an employee information database.

6. A method for assisting intelligent maintenance for a subway vehicle, wherein the method is used in the system for assisting intelligent maintenance for a subway vehicle of claim 1, the method specifically comprising:
through a pair of AR smart glasses, scanning, identifying and displaying a device under the control of a smart terminal, and cooperatively displaying a corresponding digital process guidance file;
through the smart terminal, converting a paper repair process file into a digital process guidance file using a built-in process editor, storing the digital process guidance file in a back-end system, downloading the digital process guidance file in the event of repair, inquiring device information and maintenance information from the back-end system according to scanning information of the device, generating and submitting a digital work order to a maintenance scheduling management system through the back-end system for maintenance task dispatching in response to detecting a fault, generating and submitting a repair report to the back-end system, and providing a digital note assistant function; and
through the back-end system, storing a subway vehicle maintenance database, and docking and integrating the back-end system with the existing maintenance dispatching management system through an interface.

7. The method of claim 6, wherein
the through a pair of AR smart glasses, scanning, identifying and displaying a device under the control of a smart terminal, and cooperatively displaying a corresponding digital process guidance file specifically comprises:
acquiring a voice command, a gesture command or an action command inputted by a user to control proceeding, photographing, video recording, recording and ending of operation steps in the digital process guide file;
the converting a paper repair process file into a digital process guidance file by means of a built-in process editor specifically comprises:
by means of a built-in process editor, providing a user with a function of graphically editing an operation process directly in a view area, and converting a paper repair process file into a digital process guidance file, wherein the digital process guidance file comprises a plurality of complete routing inspection operation plans and auxiliary information, wherein the routing inspection operation plans comprise a plurality of orderly operation steps, and types of the auxiliary information comprise videos, models, photos, voice and text; and
providing a digital note assistant function specifically comprises:
acquiring feedback information inputted by the user during repair through the digital note assistant function and recording the feedback information, wherein the feedback information specifically comprises: information about whether the repair has passed, current device status information, and/or device problem description information.

8. The method of claim 6, wherein the subway vehicle maintenance database specifically comprises: a maintenance process database, a device information database, a maintenance record database and an employee information database.

9. An electronic device, comprising: a memory, a processor, and a computer program stored in the memory and runnable on the processor, wherein the computer program, in response to being executed by the processor, causes the processor to implement the steps of the method for assisting intelligent maintenance for a subway vehicle of claim 6.

10. A computer-readable storage medium storing an information transfer implementation program, wherein the program, in response to being executed by a processor, causes the processor to implement the steps of the method for assisting intelligent maintenance for a subway vehicle of claim 6.
